(19) United States
(12) Patent Application Publication
(10) Pub. No.: US 2023/0385969 A1
(43) Pub. Date: Nov. 30, 2023

(54) CEMETERY MONUMENT APPLICATION SYSTEMS AND METHODS

(71) Applicants: Giuseppe Mellampe, Harrington Park, NJ (US); Nicholas Fasciglione, Bronx, NY (US); Brandon H. Johnson, McKinney, TX (US); Maximillian Heth, Plano, TX (US)

(72) Inventors: Giuseppe Mellampe, Harrington Park, NJ (US); Nicholas Fasciglione, Bronx, NY (US); Brandon H. Johnson, McKinney, TX (US); Maximillian Heth, Plano, TX (US)

(21) Appl. No.: 18/073,530

(22) Filed: Dec. 1, 2022

Related U.S. Application Data
(60) Provisional application No. 63/326,336, filed on Apr. 1, 2022.

(51) Int. Cl. G06Q 50/18; G06Q 20/02; G06Q 20/40; G06Q 20/10

(52) U.S. Cl. CPC G06Q 50/186; G06Q 20/02; G06Q 20/40; G06Q 20/10

(57) ABSTRACT

Computer-implemented computerized cemetery monument application methods, systems, and computer-readable media are described.

### RELATED APPLICATIONS

This application claims the benefit of U.S. Application No. 63/326,336, entitled “Cemetery Monument Application Systems and Methods,” and filed on Apr. 1, 2022, which is incorporated herein by reference in its entirety for all purposes.

### FIELD

Some implementations are generally related to cemetery software applications, and, in particular, to systems and methods for computerized cemetery monument application processing.

### BACKGROUND

Conventionally, the cemetery monument application process is a paper-based process that includes multiple duplicate or carbon-copy forms that are sent to various parties for signature via postal mail. Payments are typically made with a check and are sent along with these applications. These paper-based forms and associated processes may result in delays, may incur additional handling costs in the form of labor, supplies, and postage, and may also not easily permit electronic processing storage of payments and records as is common in other industries. This antiquated system also contributes to more rejections due to incorrectly filed applications. The acquiring of required information for a particular application also causes more phone calls than are needed. A need may exist for computer-implemented methods and systems for computerized processing of electronic cemetery monument applications and for the facilitation of communication between cemetery staff and monument company staff to occur digitally.

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### SUMMARY

Some implementations can include a computer-implemented method comprising receiving a selection of a cemetery at a cemetery monument application user interface provided by a computerized cemetery monument application platform; causing one or more elements of the cemetery monument application user interface to be enabled based on the cemetery selected; and receiving cemetery application information from a monument dealer system via the cemetery monument application user interface. The method can also include electronically transmitting notification of a completed cemetery monument application to an authorizing party system for approval; obtaining electronic payment from the monument dealer system via a third-party payment acquisition platform; and placing at least a portion of the electronic payment into an electronic escrow account.

The method can further include when electronic approval indication of the completed cemetery monument application is received from the authorizing party system, electronically transmitting the completed cemetery monument application to a cemetery system; when electronic approval of the completed cemetery monument application is received from the cemetery, electronically releasing the at least a portion of the electronic payment held in electronic escrow, wherein a first portion of released escrow funds is provided to the cemetery and a second portion of funds released from escrow is provided to an operator of the computerized cemetery monument application platform; and when an indication that a monument foundation is ready, generating an electronic setting card including at least a portion of the cemetery monument application and an indication that the monument is approved for setting by the cemetery. The method can also include transmitting the electronic setting card from the computerized cemetery monument application platform to one or more of the monument dealer system or the authorizing party system.

The method can further include receiving, at the computerized cemetery monument application platform, an electronic monument order for a monument dealer registered with the computerized cemetery monument application platform; providing a notification of the monument order to the monument dealer system; and generating, at the computerized cemetery monument application platform, an electronic image of a monument. The method can also include providing the electronic image of the monument from the computerized cemetery monument application platform to the authorizing party system; when the electronic image of the monument is approved by the authorizing party system, providing a notification to the monument dealer and proceeding to the cemetery monument application process; and when the electronic image of the monument is not approved by the authorizing party system, performing a design modification process.

The method can further include storing, at the computerized cemetery monument application platform, an indication that the monument has been set. The method can also include transmitting, from the computerized cemetery monument application platform, to one or more of the monument dealer system or the authorizing party system, an electronic message indicating that the monument has been set. The method can further include determining, at the computerized cemetery monument application platform, that a photo is included in a design of the monument; and requiring selection of a photo disclaimer within the cemetery monument application user interface.

The method can also include determining, at the computerized cemetery monument application platform, that a burial spaces acknowledgement is required; and requiring selection of a burial spaces acknowledgement statement within the cemetery monument application user interface. The method can further include determining, at the computerized cemetery monument application platform, that a new monument foundation is needed; and programmatically determining a cost of the new monument foundation based on one or more settings associated with the cemetery within the computerized cemetery monument application platform.

The method can also include determining, at the computerized cemetery monument application platform, that a vase in included in a design of the monument; and requiring selection of a vase disclaimer within the cemetery monument application user interface.

Some implementations can include a computerized cemetery monument application platform comprising one or more processors coupled to a computer-readable medium having stored thereon software instructions that, when executed by the one or more processors, cause the one or more processors to perform operations. The operations can include receiving a selection of a cemetery at a cemetery monument application user interface provided by the computerized cemetery monument application platform; and causing one or more elements of the cemetery monument application user interface to be enabled based on the cemetery selected.

The operations can also include receiving cemetery application information from a monument dealer system via the cemetery application user interface; electronically transmitting notification of a completed cemetery monument application to an authorizing party system for approval; and obtaining electronic payment from the monument dealer system via a third-party payment acquisition platform. The operations can further include placing at least a portion of the electronic payment into an electronic escrow account; when electronic approval indication of the completed cemetery monument application is received from the authorizing party system, electronically transmitting the completed cemetery monument application to a cemetery system; and when electronic approval of the completed cemetery monument application is received from the cemetery, electronically releasing the at least a portion of the electronic payment held in electronic escrow, wherein a first portion of released escrow funds is provided to the cemetery and a second portion of funds released from escrow is provided to an operator of the computerized cemetery monument application platform.

The operations can also include when an indication that a monument foundation is ready, generating an electronic setting card including at least a portion of the cemetery monument application and an indication that the monument is approved for setting by the cemetery; and transmitting the electronic setting card from the computerized cemetery monument application platform to one or more of the monument dealer system or the authorizing party system.

The operations can also include receiving, at the computerized cemetery monument application platform, an electronic monument order for a monument dealer registered with the computerized cemetery monument application platform; providing a notification of the monument order to the monument dealer system; and generating, at the computerized cemetery monument application platform, an electronic image of a monument. The operations can further include providing the electronic image of the monument from the computerized cemetery monument application platform to the authorizing party system; when the electronic image of the monument is approved by the authorizing party system, providing a notification to the monument dealer and proceeding to the cemetery monument application process; and when the electronic image of the monument is not approved by the authorizing party system, performing a design modification process.

The operations can also include storing, at the computerized cemetery monument application platform, an indication that the monument has been set. The operations can also include transmitting, from the computerized cemetery monument application platform, to one or more of the monument dealer system or the authorizing party system, an electronic message indicating that the monument has been set.

The operations can further include determining, at the computerized cemetery monument application platform, that a photo is included in a design of the monument; and requiring selection of a photo disclaimer within the cemetery monument application user interface.

The operations can also include determining, at the computerized cemetery monument application platform, that a burial spaces acknowledgement is required; and requiring selection of a burial spaces acknowledgement statement within the cemetery monument application user interface. The operations can further include determining, at the computerized cemetery monument application platform, that a new monument foundation is needed; and programmatically determining a cost of the new monument foundation based on one or more settings associated with the cemetery within the computerized cemetery monument application platform.

The operations can also include determining, at the computerized cemetery monument application platform, that a vase in included in a design of the monument; and requiring selection of a vase disclaimer within the cemetery monument application user interface.

The operations can further include receiving a selection of a cemetery at a cemetery monument application user interface provided by a computerized cemetery monument application platform; causing one or more elements of the cemetery monument application user interface to be enabled based on the cemetery selected; and receiving cemetery application information from a monument dealer system via the cemetery application user interface. The operations can also include electronically transmitting notification of a completed cemetery monument application to an authorizing party system for approval; obtaining electronic payment from the monument dealer system via a third-party payment acquisition platform; and placing at least a portion of the electronic payment into an electronic escrow account.

The operations can also include when electronic approval indication of the completed cemetery monument application is received from the authorizing party system, electronically transmitting the completed cemetery monument application to a cemetery system; and when electronic approval of the completed cemetery monument application is received from the cemetery, electronically releasing the at least a portion of the electronic payment held in electronic escrow, wherein a first portion of released escrow funds is provided to the cemetery and a second portion of funds released from escrow is provided to an operator of the computerized cemetery monument application platform. The operations can further include when an indication that a monument foundation is ready, generating an electronic setting card including at least a portion of the cemetery monument application and an indication that the monument is approved for setting by the cemetery; and transmitting the electronic setting card from the computerized cemetery monument application platform to one or more of the monument dealer system or the authorizing party system.

The operations can also include receiving, at the computerized cemetery monument application platform, an electronic monument order for a monument dealer registered with the computerized cemetery monument application platform; providing a notification of the monument order to the monument dealer system; and generating, at the computerized cemetery monument application platform, an electronic image of a monument. The operations can further include providing the electronic image of the monument from the computerized cemetery monument application platform to the authorizing party system; when the electronic image of the monument is approved by the authorizing party system, providing a notification to the monument dealer and proceeding to the cemetery monument application process; and when the electronic image of the monument is not approved by the authorizing party system, performing a design modification process.

The operations can also include storing, at the computerized cemetery monument application platform, an indication that the monument has been set. The operations can further include transmitting, from the computerized cemetery monument application platform, to one or more of the monument dealer system or the authorizing party system, an electronic message indicating that the monument has been set.

### BRIEF DESCRIPTION OF THE DRAWINGS

FIG. 1 is a block diagram of an example system and a network environment which may be used for one or more implementations described herein.

FIG. 2 is a diagram showing example application types within an example cemetery monument application system in accordance with some implementations.

FIG. 3 is a flowchart showing an example cemetery monument application process in accordance with some implementations.

FIG. 4 is a flowchart showing details of an example cemetery monument application process in accordance with some implementations.

FIG. 5 is a diagram showing an example computerized cemetery monument application graphical user interface for selecting a type of work to be performed in accordance with some implementations.

FIG. 6 is a diagram showing an example computerized cemetery monument application graphical user interface for other work in accordance with some implementations.

FIG. 7 is a diagram showing an example computerized cemetery monument application graphical user interface for a new monument application process in accordance with some implementations.

FIG. 8 is a diagram showing an example computerized cemetery monument application graphical user interface for a new monument foundation application showing required fields and files which must be provided in order to move forward with sending of the application in accordance with some implementations.

FIG. 9 is a diagram showing an example computerized cemetery monument application graphical user interface for an inscription application in accordance with some implementations.

FIG. 10 is a diagram showing an example computerized cemetery monument application graphical user interface showing required fields and files which must be provided in order to move forward with sending of the application.

FIG. 11 is a diagram showing an example computerized cemetery monument application graphical user interface showing required fields which must be provided in order to move forward with sending of the application.

FIG. 12 is a diagram showing an example computerized cemetery monument application graphical user interface for a new monument foundation application completion confirmation in accordance with some implementations.

FIG. 13 is a diagram showing an example computerized cemetery monument application graphical user interface for a reface application in accordance with some implementations.

FIG. 14 is a diagram showing an example computerized cemetery monument application graphical user interface for a new monument foundation application plot information in accordance with some implementations.

FIG. 15 is a diagram showing an example computerized cemetery monument application graphical user interface on the monument company side for a new monument foundation application awaiting authorizing party approval/e-signature in accordance with some implementations.

FIG. 16 is a diagram showing an example computerized cemetery monument application graphical user interface on the monument company side for a new monument foundation application awaiting transmitting to the cemetery in accordance with some implementations.

FIG. 17 is a diagram showing an example computerized cemetery monument application graphical user interface on the monument company side for a new monument foundation application awaiting cemetery approval in accordance with some implementations.

FIG. 18 is a diagram showing an example computerized cemetery monument application graphical user interface on the monument company side for a new monument foundation application awaiting foundation pouring status in accordance with some implementations.

FIG. 19 is a diagram showing an example computerized cemetery monument application graphical user interface for a new monument foundation application awaiting monument set status in accordance with some implementations.

FIG. 20 is a diagram showing an example computerized cemetery monument application graphical user interface for a new monument foundation application showing new monument complete status in accordance with some implementations.

FIGS. 21A and 21B are diagrams showing an example computerized cemetery monument application graphical user interface for a new monument foundation application from the perspective of a cemetery user system in accordance with some implementations.

FIG. 22 is a diagram showing an example computerized cemetery monument application graphical user interface for a new monument foundation application from the perspective of a cemetery user system in which the application has been approved and is awaiting foundation pouring in accordance with some implementations.

FIG. 23 is a diagram showing an example computerized cemetery monument application graphical user interface for a new monument foundation application from the perspective of a cemetery user system in which the foundation pouring is complete in accordance with some implementations.

FIG. 24 is a block diagram of an example computing device which may be used for one or more implementations described herein.

FIG. 25 is a user interface diagram showing an example notification to a cemetery user that an application is ready for review/approval in accordance with some implementations.

FIG. 26 is a flowchart of an example optional process that can be performed as part of the cemetery application process as described herein in accordance with some implementations.

### DETAILED DESCRIPTION

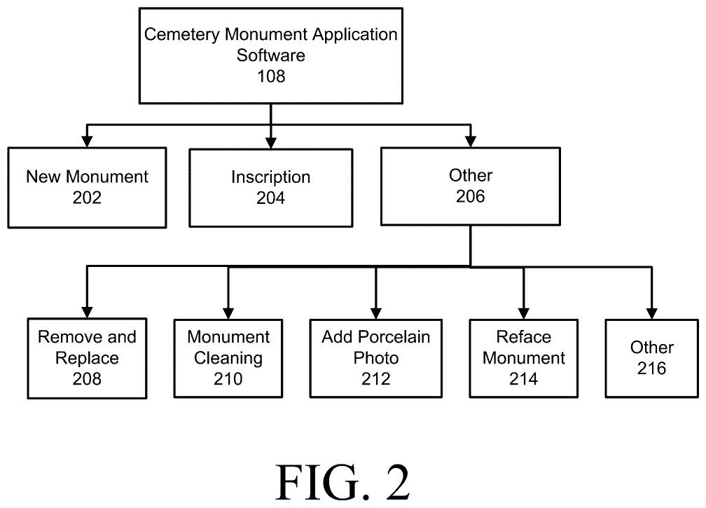

Some implementations include computerized cemetery monument application methods and systems. While a detailed example is described below in connection with a new monument order, a similar process of monument dealer/manufacturer application and cemetery approval carried out within a computerized cemetery monument application platform as described herein can be followed for other types of work being performed such as those shown in FIG. 2.

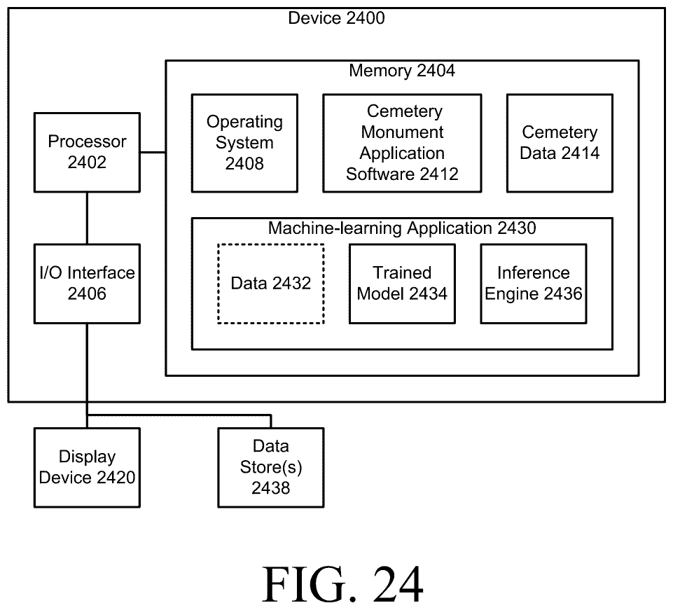

When performing computerized cemetery monument application functions, it may be helpful for a system to suggest next steps and/or to make predictions about approval likelihood or timing. To make predictions or suggestions, a probabilistic model (or other model as described below in conjunction with FIG. 24) can be used to make an inference (or prediction) about aspects of computerized cemetery monument application processing such as approval likelihood and/or timing. Accordingly, it may be helpful to make an inference regarding a probability that a cemetery application will be approved and a prediction of when the application will be approved, or the monument will be set. Other aspects can be predicted or suggested as described below.

The systems and methods provided herein may overcome one or more deficiencies of some conventional paper-based cemetery monument application systems and methods. For example, in conventional paper-based cemetery application processes, there may be a need for electronic records, which may require scanning paper-based forms to generate electronic images that can be stored. Some implementations of the computerized cemetery monument application systems and methods described herein include an electronic application process that reduces the memory needed to store electronic records of the cemetery monument application, can enhance security by providing electronic payment and escrow of funds, and can provide searchable electronic records that include a combination of application details, any communications regarding the application, payment details, escrow details, and other details such as dates and users/authorizing parties involved in the process. These features provide a technical solution to the technical problems and limitations of conventional electronic storage of paper-based forms.

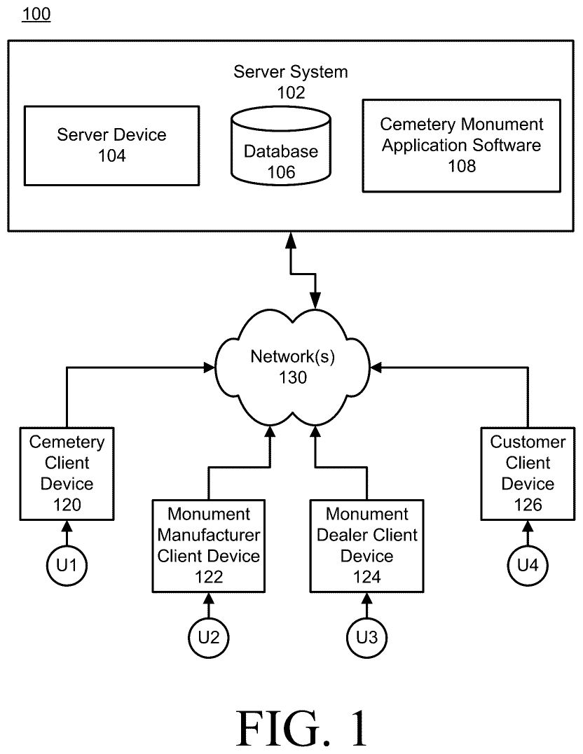

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104 and a database 106 or other data store or data storage device, and a computerized cemetery monument application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126 (e.g., including a cemetery client device, a monument manufacturer client device, a monument dealer client device, and an authorizing party/customer client device, respectively). Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide computerized cemetery monument application functions as described below.

Various implementations of features described herein can use any type of system and/or service. Any type of electronic device can make use of features described herein. Some implementations can provide one or more features described herein on client or server devices disconnected from or intermittently connected to computer networks.

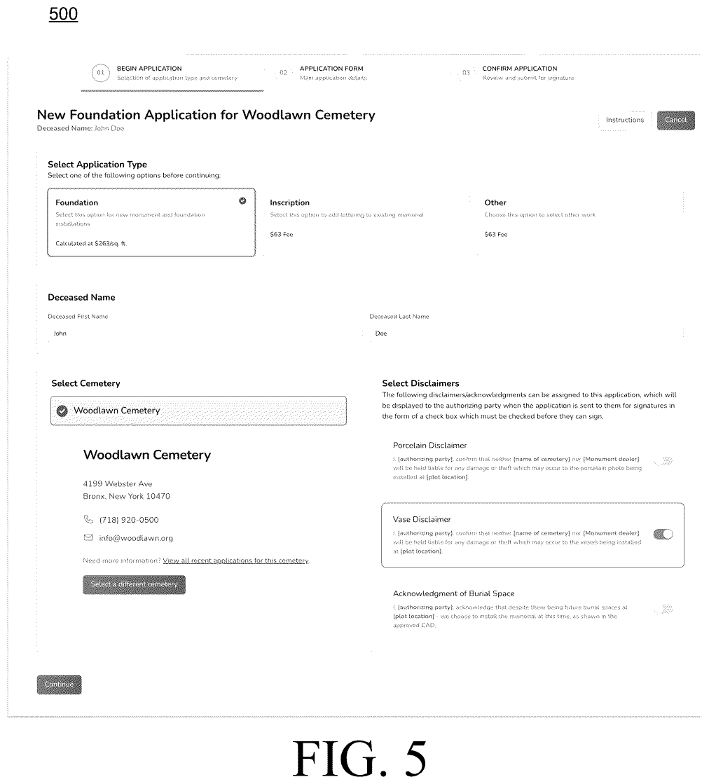

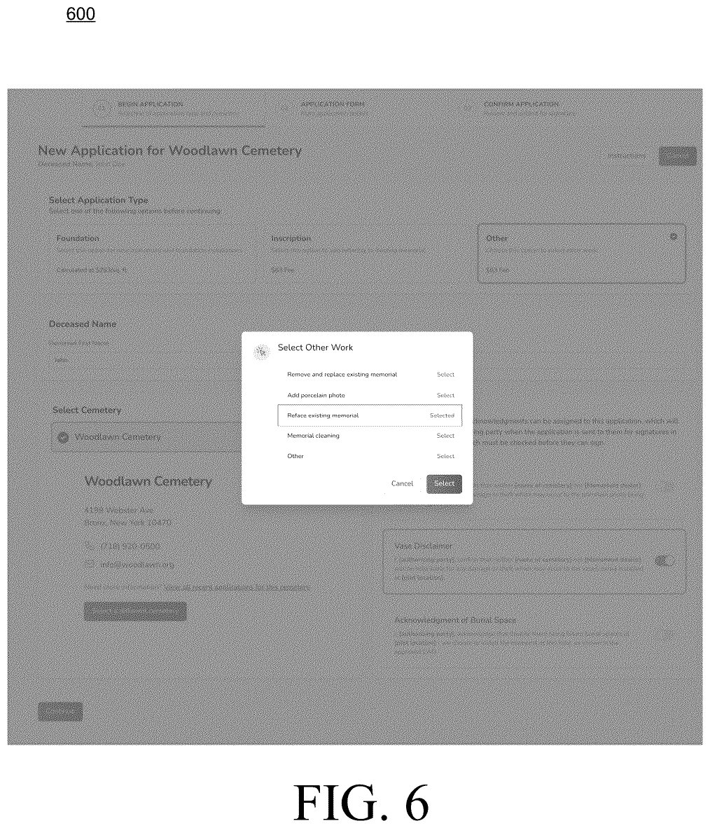

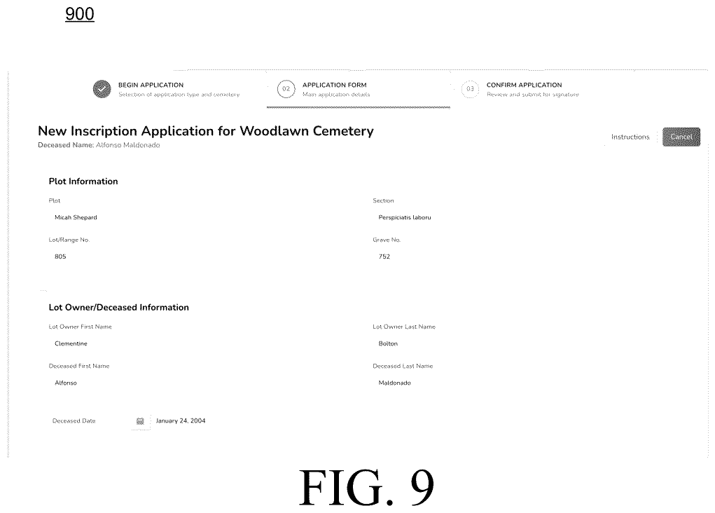

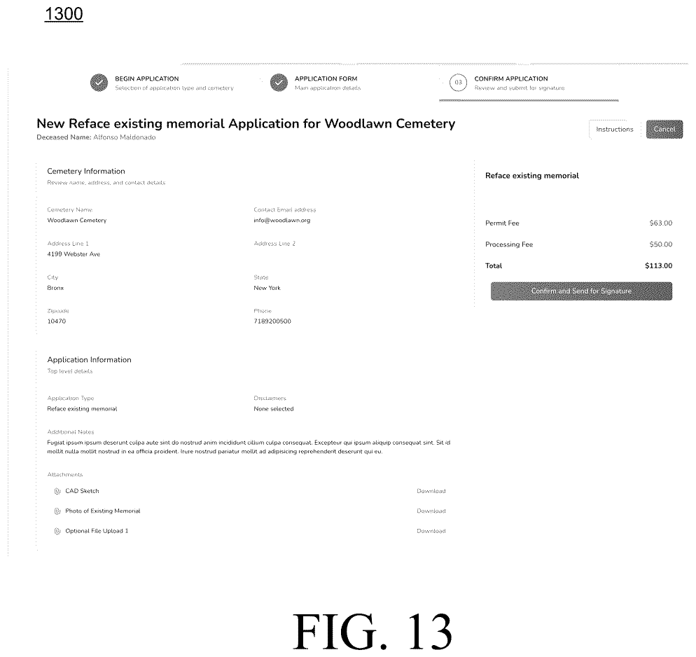

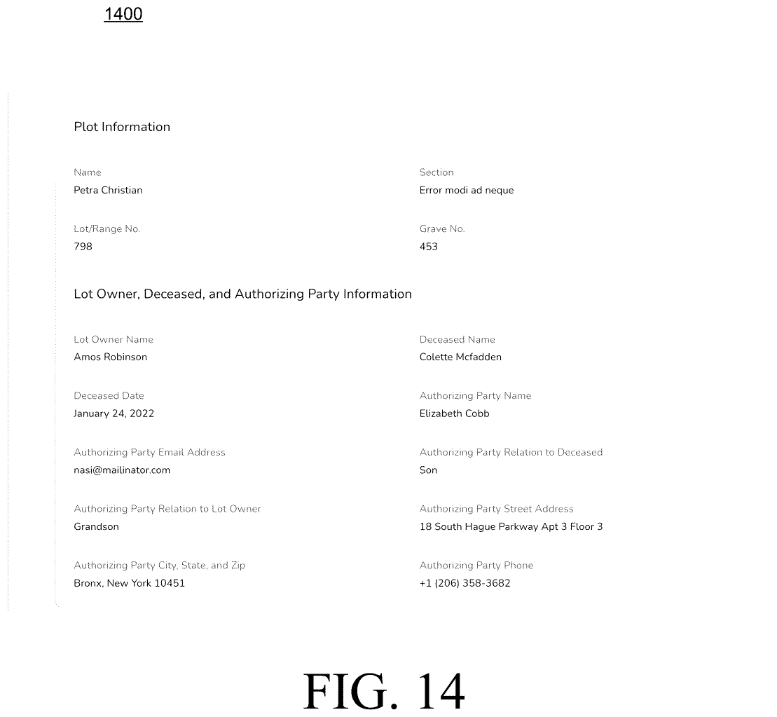

FIG. 2 is a diagram showing example application types within an example cemetery monument application system in accordance with some implementations. In particular, FIG. 2 shows cemetery monument application software 108 with functional modules for a new monument 202, an inscription 204 (with example graphical user interfaces shown in FIGS. 9-11), and other services 206. The other services 206 can include remove and replace monument 208, monument cleaning 210, adding a porcelain photo 212, refacing a monument 214 (with example graphical user interface shown in FIGS. 13 and 14), and other services 216. An example graphical user interface for the selection of the service types is shown below in FIGS. 5 and 6.

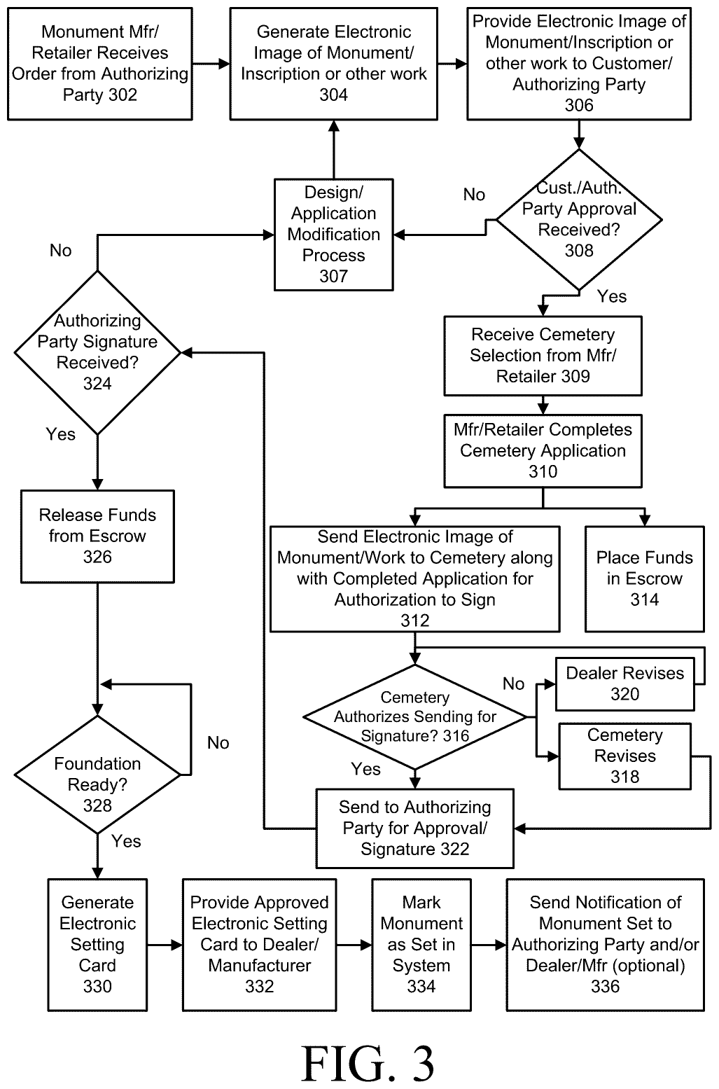

FIG. 3 is a flowchart showing an example cemetery monument application process in accordance with some implementations. Processing begins at 302, where a monument dealer/retailer/manufacturer (or simply “dealer”) receives an order for a monument (or monument related service) from an authorizing party (or customer). The order is received directly at the monument dealer. Processing continues to 304.

At 304, the monument dealer generates an electronic image of a proposed monument or inscription. The electronic image can be generated by a computer-aided design (CAD) system that is a separate program or one integrated into the computerized cemetery monument application platform. Processing continues to 306.

At 306, the electronic image of the monument is provided from the monument dealer to an authorizing party (e.g., the customer). For example, in some implementations, the computerized cemetery monument application platform can electronically transmit the electronic monument image to an authorizing party system. Processing continues to 308.

At 308, it is determined whether approval of the electronic image of the monument is received from the authorizing party. For example, the computerized cemetery monument application platform can wait for and receive electronic approval (e.g., signature or the like) of the monument image from the authorizing party system. If approval is received, processing continues to 309. Otherwise, processing continues to 307 where a design or application modification process is performed, and processing continues back to 304.

At 309, a selection of a cemetery is received at the computerized cemetery monument application platform. For example, a monument dealer system can initiate a new monument application by selecting a cemetery (see, e.g., FIG. 5), which can cause the computerized cemetery monument application platform to present options based on the cemetery selection. For example, some cemeteries require different information to be provided with applications than some others. Also, some cemeteries have certain monument design requirements, such as display of a cross of a given size on every monument. Processing continues to 310.

At 310, a new monument application is completed by a monument dealer. For example, as shown in FIG. 5, the monument dealer can select the type of application being initiated, which can include the service types described above in connection with FIG. 2.

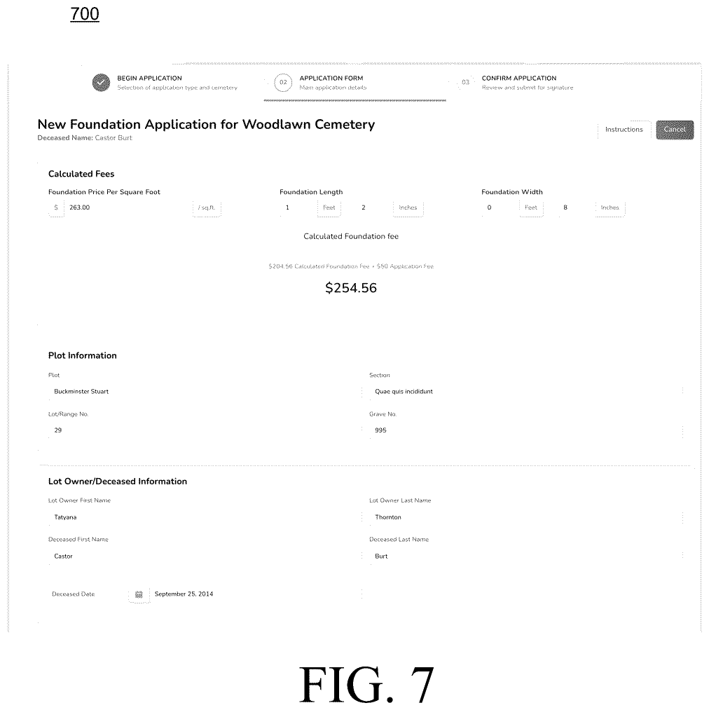

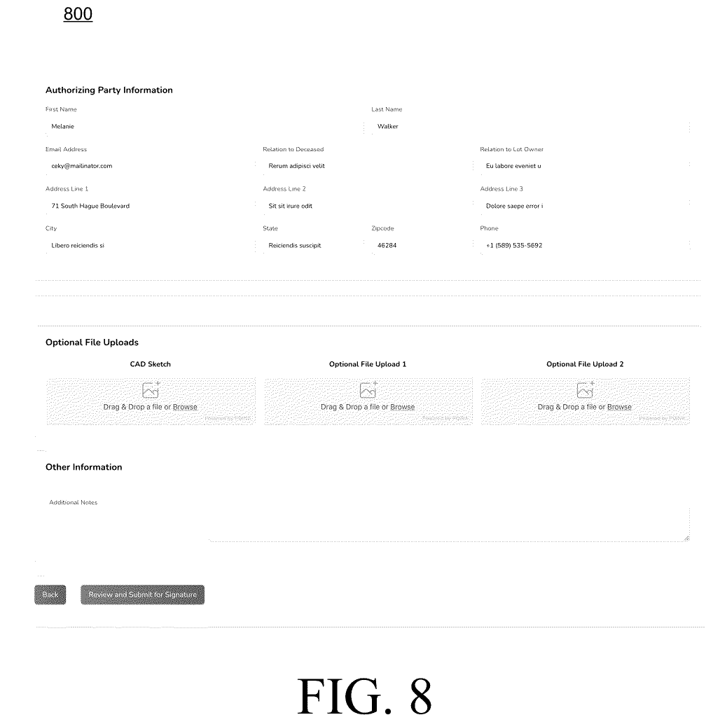

FIGS. 7 and 8 show example graphical user interfaces for entering new monument cemetery application information including foundation cost calculation (also discussed below), plot information, lot owner information, authorizing party information, and elements for attaching required electronic images or other documents to accompany the application. Processing continues to 312/314.

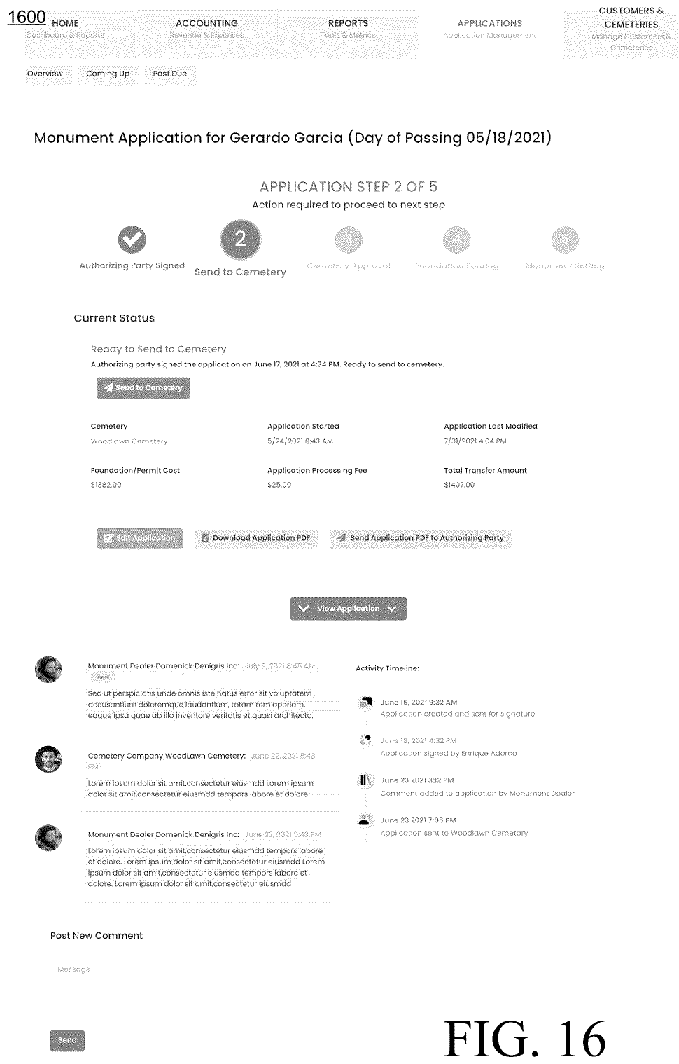

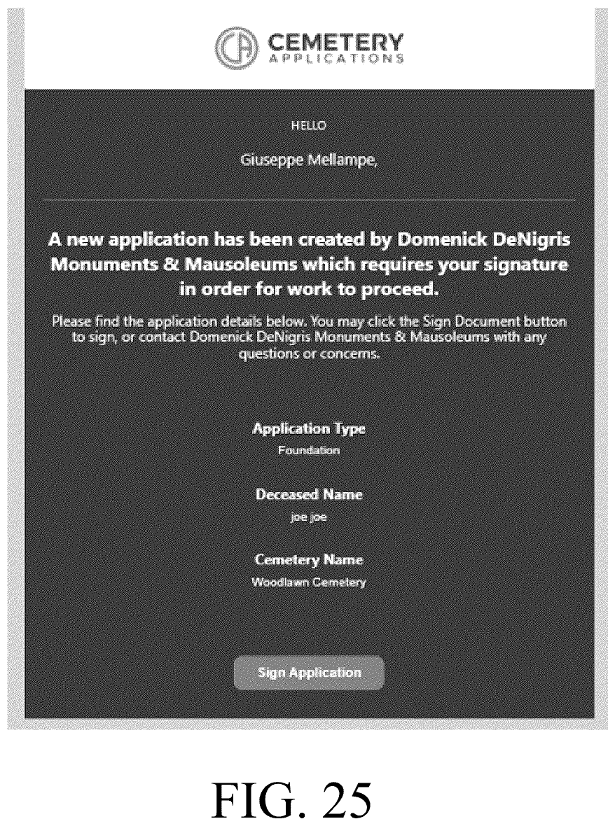

At 312, once the dealer system has provided the necessary information to complete the cemetery monument application, the application (and an electronic image of the monument/work) is electronically transmitted to a cemetery for authorization to sign. For example, the complete application including electronic monument images is electronically transmitted (or an electronic notification of complete application is provided) to the cemetery system. The cemetery can receive a notification such as that show in FIG. 25. An example of the graphical user interface for this stage is shown in FIG. 16.

At 314, in connection with the completion of the application and transmitting to the authorizing party, the monument dealer is charged a fee that includes a portion for the cemetery and a portion for the computerized cemetery monument application platform and those funds are held in electronic escrow. The payment and electronic escrow can be processed by a third-party payment acquisition platform.

Processing continues from 312 to 316.

At 316, it is determined if the cemetery authorizes sending the application for signature by authorizing party. If so, processing continues to 322. Otherwise, processing can continue to 320 for the dealer to make revisions to the application and resubmit to the cemetery at for approval at 316. Or, at 318, the cemetery can revise the application and processing continues to 322.

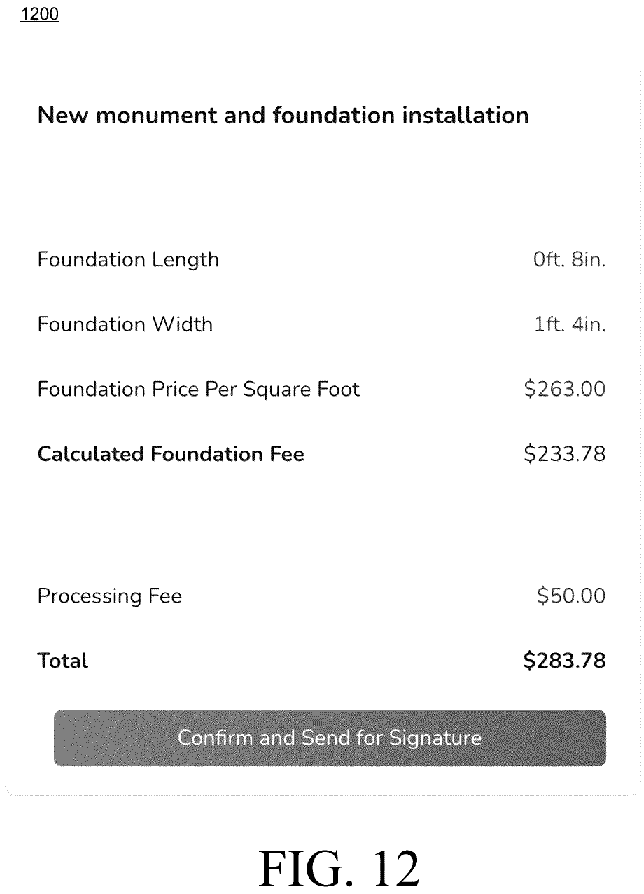

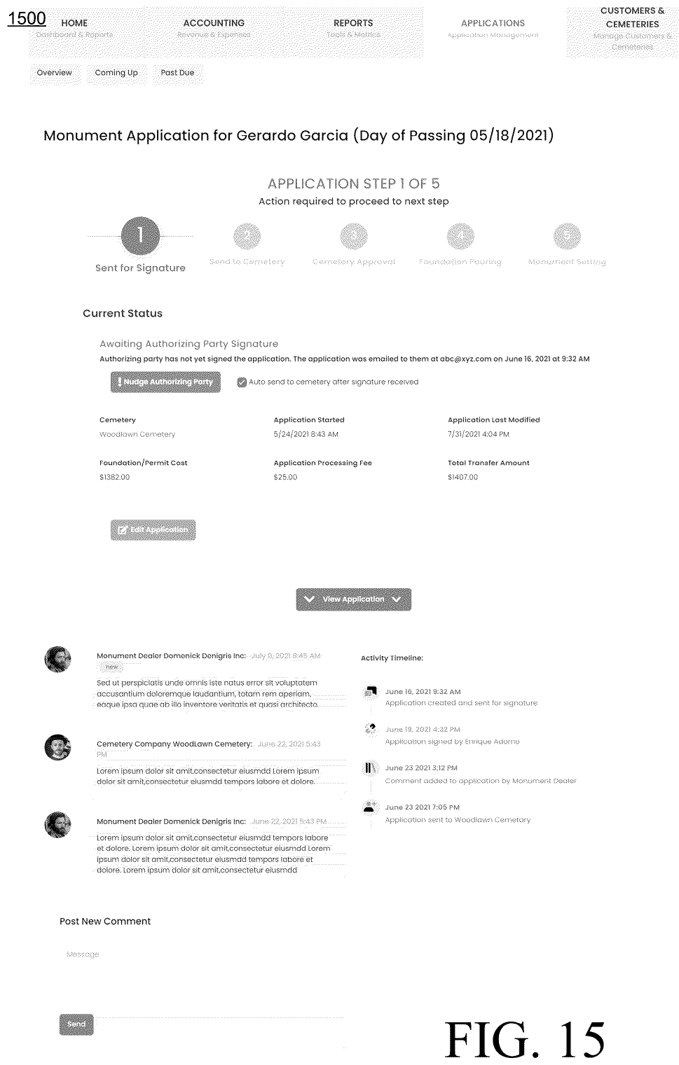

At 322, the completed application (approved by the cemetery) is sent to the authorizing party for signature. An authorizing party system for signature/approval as shown in FIG. 15. A graphical user interface for the approval and transmitting is shown in FIG. 12. Processing continues to 324.

At 324, it is determined if the authorizing party approval/electronic signature was received. If so, once the completed application has been approved and e-signed by the authorizing party system, the complete application including electronic monument images is electronically transmitted (or an electronic notification of complete application is provided) to the cemetery system. The cemetery can receive a notification such as that show in FIG. 25. An example of the graphical user interface for this stage is shown in FIG. 16. Processing continues to 326. If the authorizing party does not approve or electronically sign, processing continues back to 307 for a design or application modification process.

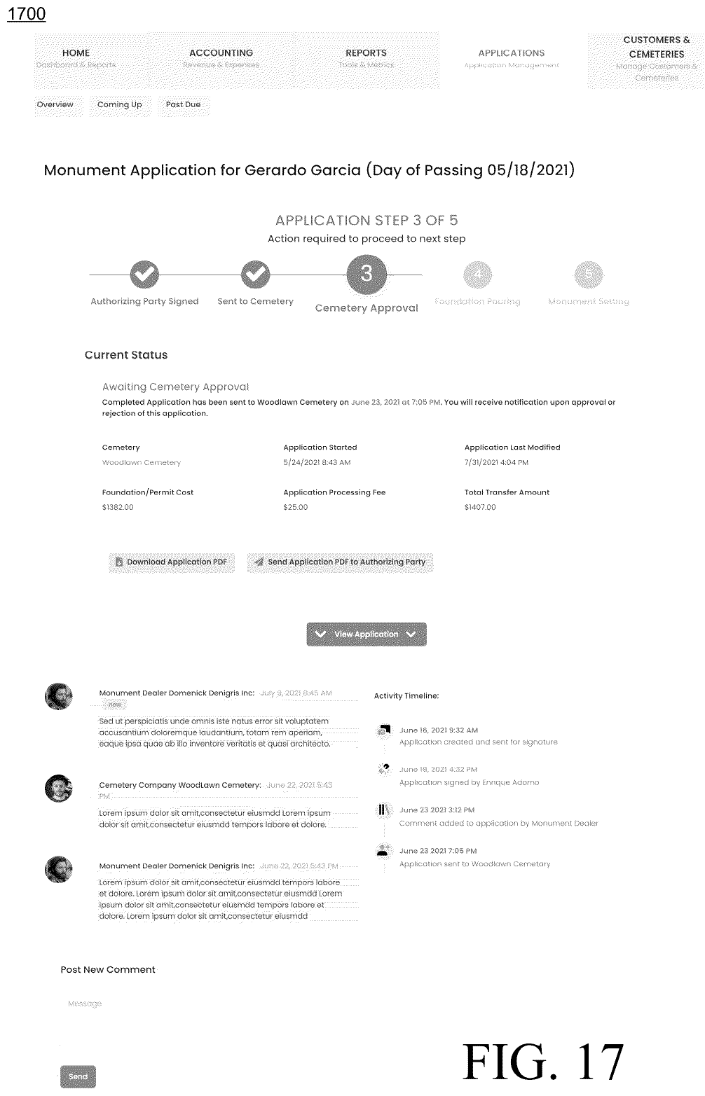

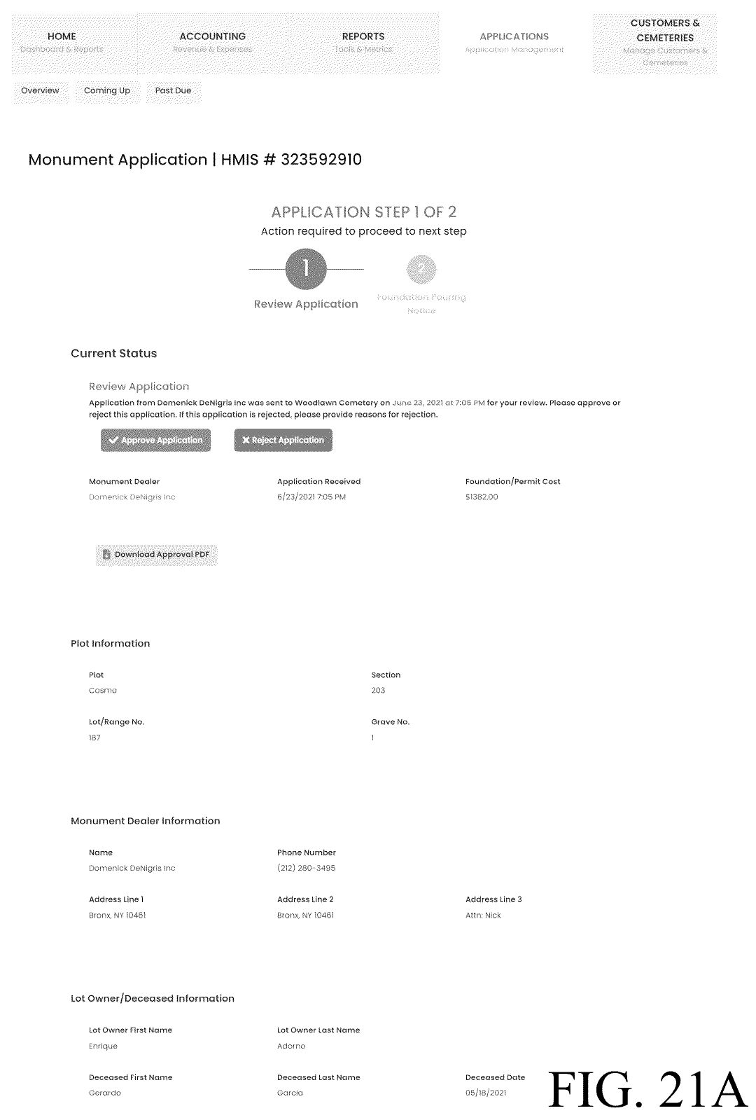

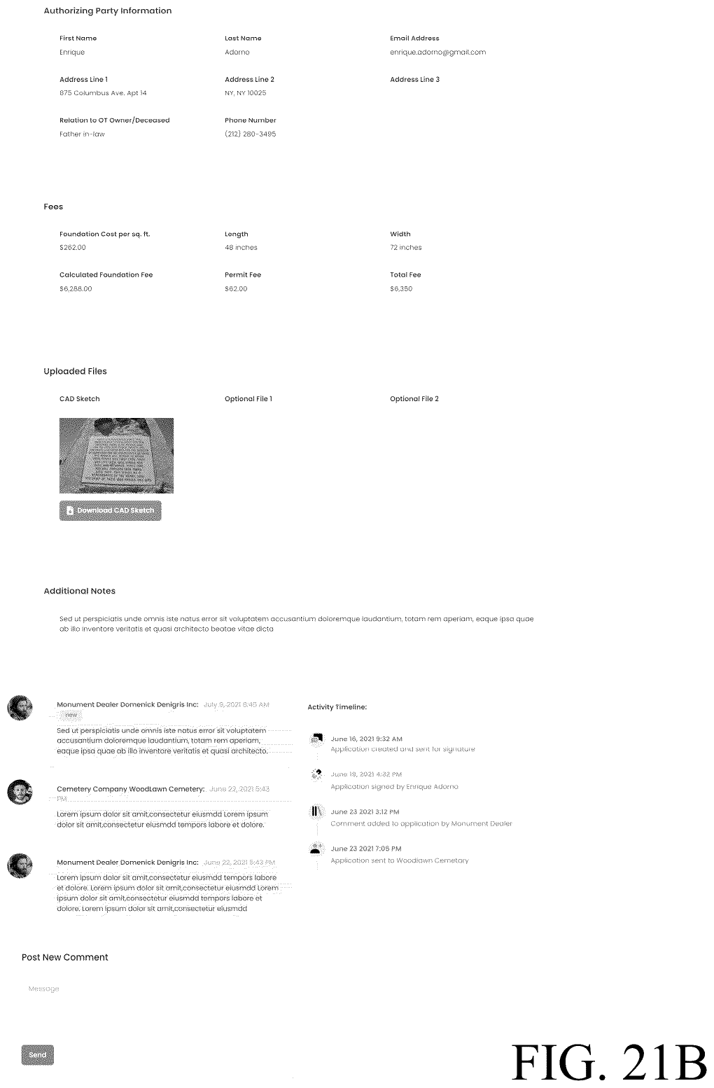

At 316, the computerized cemetery monument application platform determines whether cemetery approval has been received. When cemetery approval is received, processing continues to 318. An example user interface screen of this step from the monument dealer view is shown in FIG. 17. An example graphical user interface screen from the cemetery view is shown in FIGS. 21A and 21B. When cemetery approval is not received (e.g., the cemetery rejects the application), a notification that can include the reason for rejection is sent to the monument dealer via the computerized cemetery monument application platform and processing returns to 307 for a monument design or application modification process.

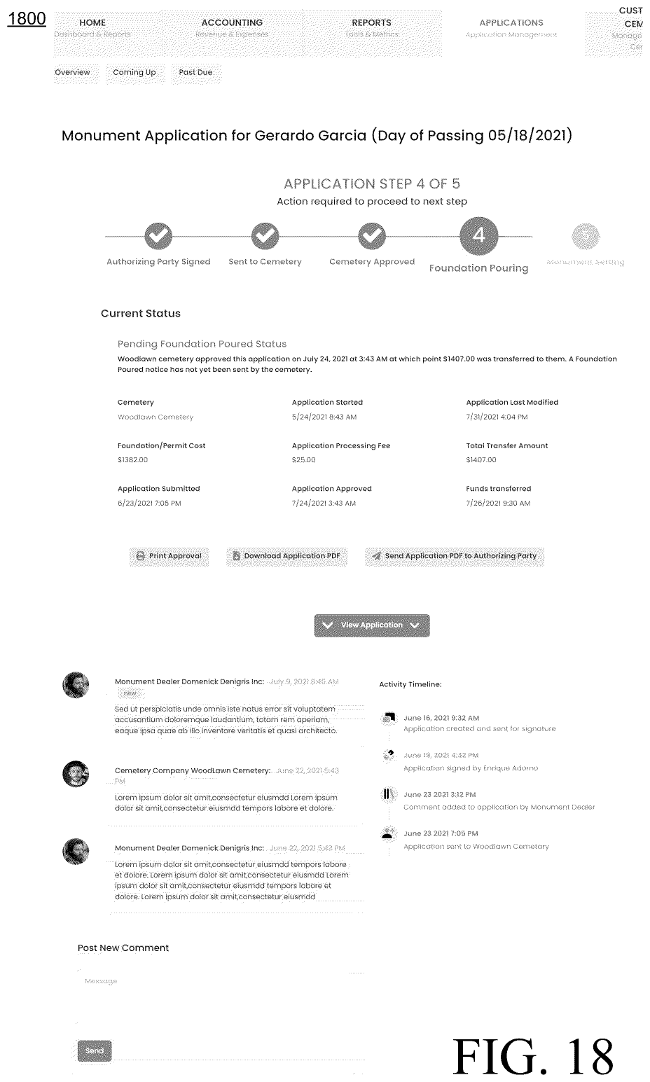

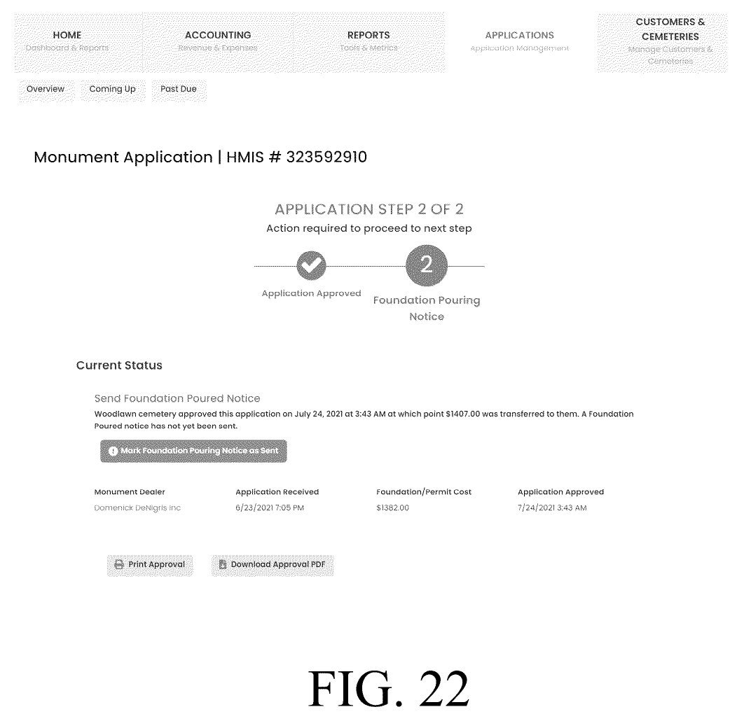

At 326, when cemetery approval is received, funds held in electronic escrow are released with a portion being electronically sent to the cemetery for deposit and a portion being electronically sent for deposit into an account of the computerized cemetery monument application platform operator. An example graphical user interface screen for this step from the monument dealer perspective is shown in FIG. 18. An example graphical user interface screen from the cemetery perspective is shown in FIG. 22. Processing continues to 328.

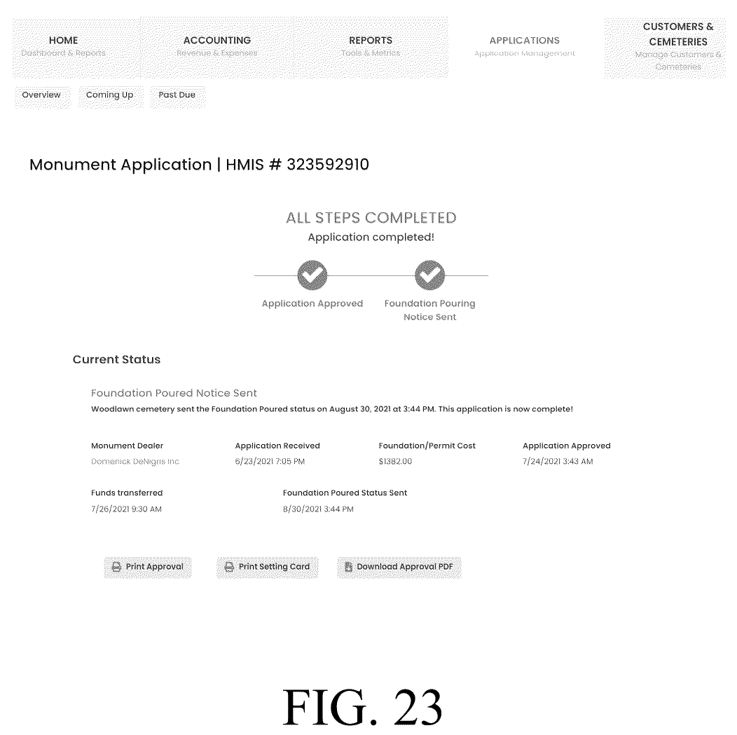

At 328, the computerized cemetery monument application platform awaits receiving an indication that a foundation is ready (e.g., the cemetery can communicate that the foundation is poured and ready for setting, if applicable). An example graphical user interface screen for this step from the monument dealer perspective is shown in FIG. 18. An example graphical user interface screen from the cemetery perspective is shown in FIG. 23. This step is optional based on the cemetery selection as some cemeteries have pre-poured foundations and some may not use a foundation at all. Processing continues to 330.

At 330, the computerized cemetery monument application platform generates an electronic setting card. For example, the computerized cemetery monument application platform can generate an electronic document (e.g., in PDF format) that includes the application information, authorizing party signature/approval and cemetery signature/approval. The electronic setting card can also include an indication (e.g., a watermark of “Approved to Set” or the like) that shows the monument is approved for setting. In some implementations, the electronic setting card can include a computer-readable indicium (e.g., a QR code, bar code or the e like) such that when the electronic setting card image is presented to a cemetery, the cemetery can scan the computer-readable indicium and the cemetery system or device can transmit a notification to the system that the setting is taking place. Processing continues to 332.

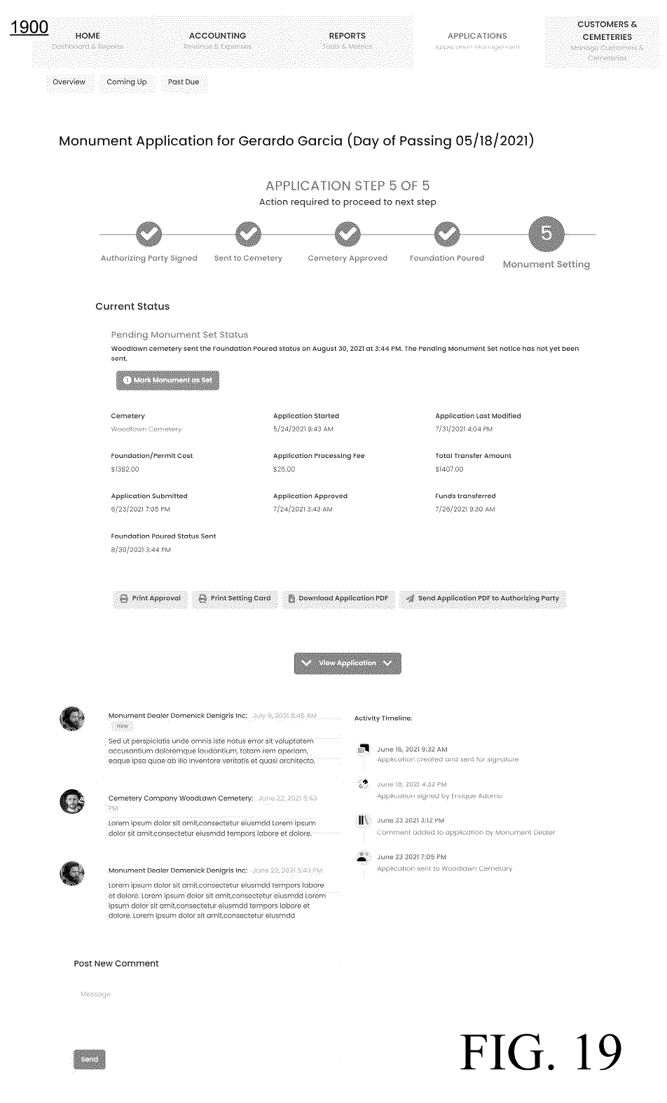

At 332, the electronic setting card is electronically transmitted to the monument dealer (e.g., emailed to the monument dealer or made available for download within the computerized cemetery monument application platform. FIG. 19 shows an example graphical user interface from the monument dealer perspective that shows the process stage is awaiting setting. Processing continues to 334.

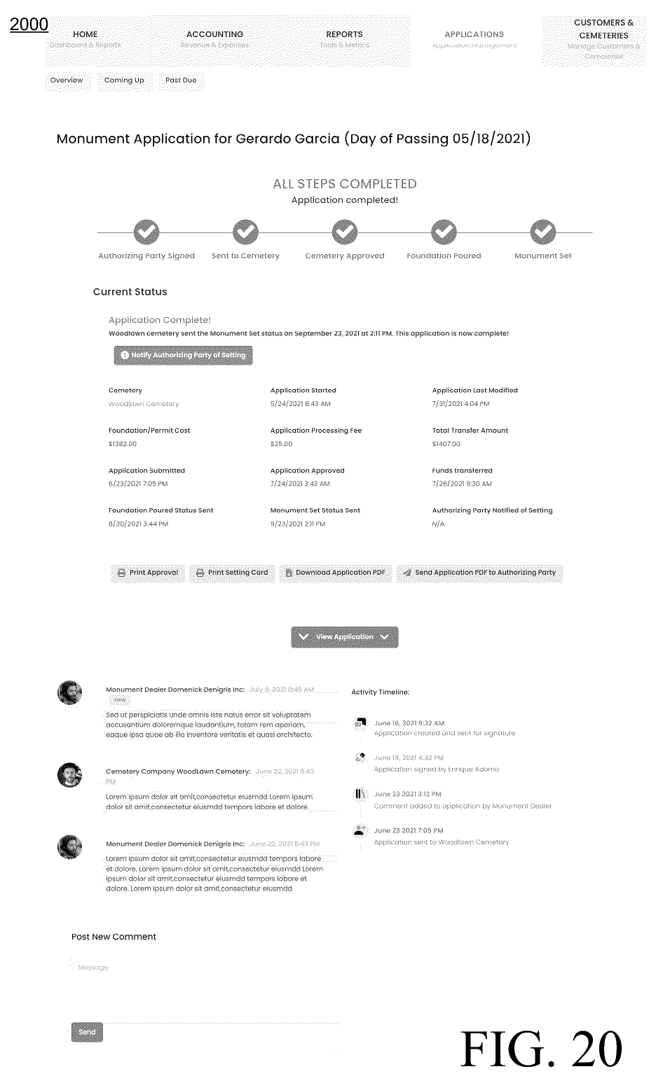

At 326, once confirmation is received that the monument has been set, which can optionally include an electronic image of the set monument, the monument dealer user interface can reflect that status (e.g., as shown in FIG. 20) and the status can be recorded in the computerized cemetery monument application platform. Processing continues to 336.

At 336, a notification of monument setting complete is optionally sent to the monument dealer system and/or the authorizing party system. This notification can optionally include an electronic image of the set monument.

It will be appreciated, in some implementations, that 302-336 can be performed in whole or in part in the order shown in FIG. 3 or a different order.

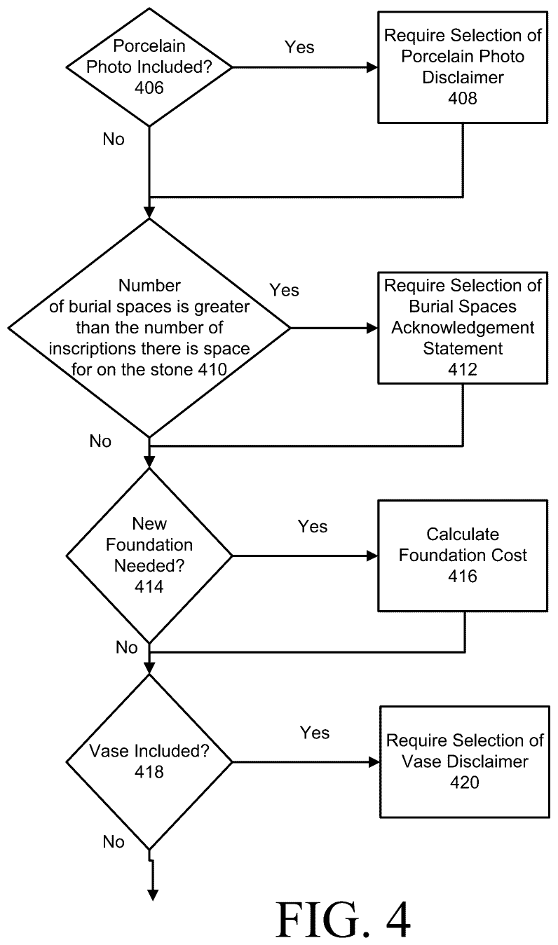

FIG. 4 is a flowchart showing details of an example cemetery monument application process in accordance with some implementations. As shown in FIG. 4, processing can begin at 406, where the computerized cemetery monument application platform can determine if a photo (e.g., porcelain photo) is to be included in a monument (e.g., via input from the monument dealer system). If so, processing continues to 408. Otherwise, processing continues to 410.

At 408, a selection of a porcelain photo disclaimer within the monument dealer graphical user interface of the computerized cemetery monument application platform is required. See, for example, FIG. 5. Processing continues to 410.

At 410, the computerized cemetery monument application platform can determine if the number of burial spaces is greater than the number of inscriptions there is space for on the stone. For example, if the plot is for two burials and an authorizing party decides it will only use the plot for 1 burial and the monument will only reflect one burial, a disclaimer/acknowledgement needs to be included. If so, processing continues to 412. Otherwise, processing continues to 414.

At 412, a selection of a burial space acknowledgement within the monument dealer graphical user interface of the computerized cemetery monument application platform is required. See, for example, FIG. 5. Processing continues to 414.

At 414, the computerized cemetery monument application platform can determine if a foundation pouring cost is needed (e.g., via input from the monument dealer system). If so, processing continues to 416. Otherwise, processing continues to 418.

At 416, the computerized cemetery monument application platform can programmatically calculate the foundation cost using one or more factors such as cost per square foot, length measurement, and width measurement. See, for example, FIG. 7. Processing continues to 418.

At 418, the computerized cemetery monument application platform can determine if a vase is included as part of the monument (e.g., via input from the monument dealer system). If so, processing continues to 420.

At 420, a selection of a vase disclaimer within the monument dealer graphical user interface of the computerized cemetery monument application platform is required. See, for example, FIG. 5.

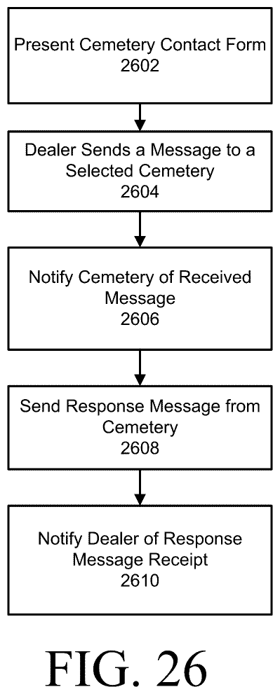

Optionally, as part of the cemetery application process, a process can permit monument dealer/manufacturer/retailers to contact a cemetery through the system in order to ask key information the dealer may need to process the application. As shown in FIG. 26,

Currently every time a dealer works with a customer, they will contact (mostly through phone calls) the cemetery on the customer's behalf in order to gather information such as plot location in cemetery, what monument type and size are allowed on said plot, and who is the authorizing party for the plot. A customer that is shopping around may have multiple dealers contact the cemetery for the same person.

Some implementations can include a contact form/inquiry system for dealers to contact the cemetery through the website for the above-mentioned information. The cemetery would then be able to answer all these requests in one place on their end of the system.

As shown in FIG. 26, processing for this sub-process begins at 2602, where a cemetery contact form is presented. Processing continues to 2604.

At 2604, the dealer sends a message to a cemetery through the cemetery application system. Processing continues to 2606.

At 2606, the system notifies the cemetery of the message. Processing continues to 2608.

At 2608, the cemetery can respond with a custom message or a saved message (e.g., list of monument rules or guidelines for the cemetery, etc.). Processing continues to 2610.

At 2610, the system notifies the dealer of a response to the message. The process of FIG. 26 (or any other flowcharts herein) can be repeated in whole or in part to accomplish a cemetery application task.

FIG. 5 is a diagram showing an example computerized cemetery monument application graphical user interface 500 for selecting a service type in accordance with some implementations.

FIG. 6 is a diagram showing an example computerized cemetery monument application graphical user interface 600 for other work in accordance with some implementations.

FIG. 7 is a diagram showing an example computerized cemetery monument application graphical user interface 700 for a new monument foundation application and foundation cost calculation in accordance with some implementations.

FIG. 8 is a diagram showing an example computerized cemetery monument application graphical user interface 800 for a new monument foundation application displaying required fields and files which need to be sent along with the cemetery application.

FIG. 9 is a diagram showing an example computerized cemetery monument application graphical user interface 900 for an inscription application displaying required fields which need to be sent along with the cemetery application. in accordance with some implementations.

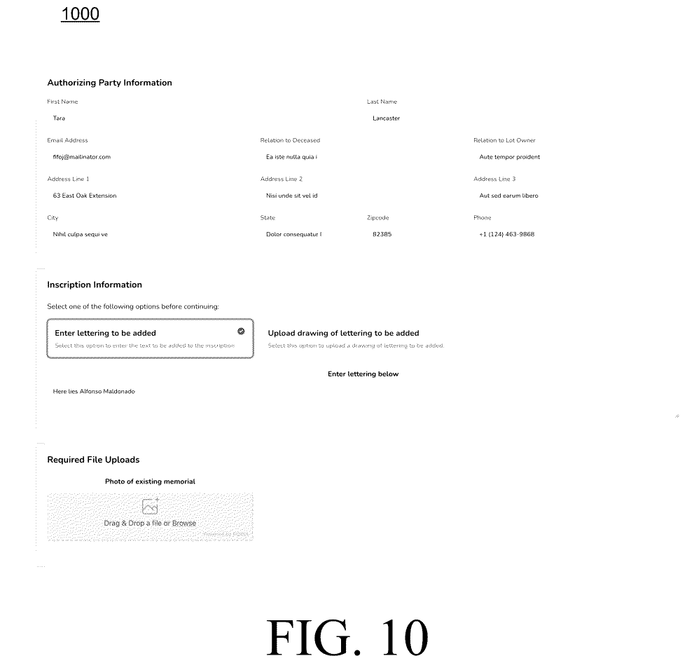

FIG. 10 is a diagram showing an example computerized cemetery monument application graphical user interface 1000 for an inscription application displaying required fields and/or files which need to be sent along with the cemetery application. in accordance with some implementations.

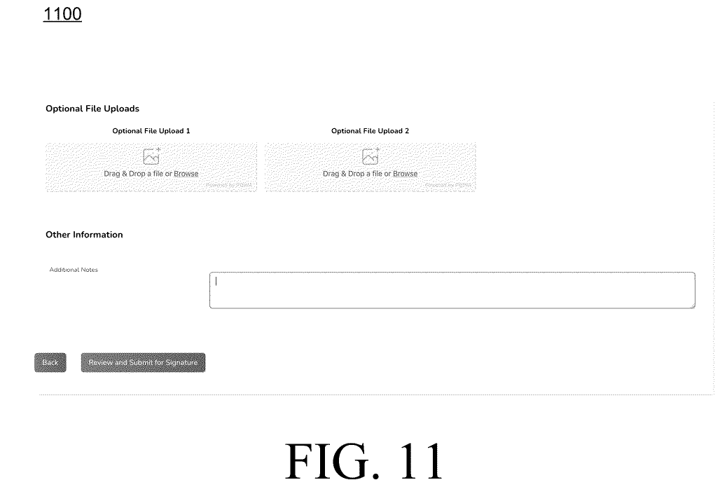

FIG. 11 is a diagram showing an example computerized cemetery monument application graphical user interface 1100 for an inscription application in accordance with some implementations.

FIG. 12 is a diagram showing an example computerized cemetery monument application graphical user interface 1200 for a new monument foundation application completion confirmation in accordance with some implementations. When a monument dealer user confirms and sends for signature, this application is electronically sent to the authorizing party for their e-signature.

FIG. 13 is a diagram showing an example computerized cemetery monument application graphical user interface 1300 for a reface application in accordance with some implementations.

FIG. 14 is a diagram showing an example computerized cemetery monument application graphical user interface 1400 for a new monument foundation showing all of the information provided on this application in accordance with some implementations.

FIG. 15 is a diagram showing an example computerized cemetery monument application graphical user interface 1500 for a new monument foundation application awaiting authorizing party approval/e-signature in accordance with some implementations.

FIG. 16 is a diagram showing an example computerized cemetery monument application graphical user interface 1600 for a new monument foundation application awaiting transmitting to cemetery in accordance with some implementations.

FIG. 17 is a diagram showing an example computerized cemetery monument application graphical user interface 1700 for a new monument foundation application awaiting cemetery approval in accordance with some implementations.

FIG. 18 is a diagram showing an example computerized cemetery monument application graphical user interface 1800 for a new monument foundation application awaiting foundation pouring status in accordance with some implementations.

FIG. 19 is a diagram showing an example computerized cemetery monument application graphical user interface 1900 for a new monument foundation application awaiting monument set status in accordance with some implementations.

FIG. 20 is a diagram showing an example computerized cemetery monument application graphical user interface 2000 for a new monument foundation application showing new monument complete status in accordance with some implementations.

FIGS. 21A and 21B are diagrams showing an example computerized cemetery monument application graphical user interface for a new monument foundation application from the perspective of a cemetery user system in accordance with some implementations.

FIG. 22 is a diagram showing an example computerized cemetery monument application graphical user interface for a new monument foundation application from the perspective of a cemetery user system in which the application has been approved and is awaiting foundation pouring in accordance with some implementations.

FIG. 23 is a diagram showing an example computerized cemetery monument application graphical user interface for a new monument foundation application from the perspective of a cemetery user system in which the foundation pouring is complete in accordance with some implementations.

FIG. 24 is a block diagram of an example device 2400 which may be used to implement one or more features described herein. In one example, device 2400 may be used to implement a client device, e.g., any of client devices 120-126 shown in FIG. 1. Alternatively, device 2400 can implement a server device, e.g., server device 104, etc. In some implementations, device 2400 may be used to implement a client device, a server device, or a combination of the above. Device 2400 can be any suitable computer system, server, or other electronic or hardware device as described above.

One or more methods described herein (e.g., some or all of FIGS. 3 and 4) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 2400 includes a processor 2402, a memory 2404, and I/O interface 2406. Processor 2402 can be one or more processors and/or processing circuits to execute program code and control basic operations of the device 2400. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 2402 may include one or more co-processors that implement neural-network processing. In some implementations, processor 2402 may be a processor that processes data to produce probabilistic output, e.g., the output produced by processor 2402 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 2404 is typically provided in device 2400 for access by the processor 2402 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 2402 and/or integrated therewith. Memory 2404 can store software operating on the server device 2400 by the processor 2402, including an operating system 408, machine-learning application 2430, computerized cemetery monument application 2412, and application data 2414. Other applications may include applications such as a data display engine, web hosting engine, image display engine, notification engine, social networking engine, etc. In some implementations, the machine-learning application 2430 and computerized cemetery monument application 2412 can each include instructions that enable processor 2402 to perform functions described herein, e.g., some or all of the methods of FIGS. 3 and 4.

The machine-learning application 2430 can include one or more NER implementations for which supervised and/or unsupervised learning can be used. The machine learning models can include multi-task learning based models, residual task bidirectional LSTM (long short-term memory) with conditional random fields, statistical NER, etc. The Device can also include a computerized cemetery monument application 2412 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 2430 may utilize Bayesian classifiers, support vector machines, neural networks, or other learning techniques. In some implementations, machine-learning application 2430 may include a trained model 2434, an inference engine 2436, and data 2432. In some implementations, data 2432 may include training data, e.g., data used to generate trained model 2434. For example, training data may include any type of data suitable for training a model for computerized cemetery monument application tasks, such as images, labels, thresholds, etc. associated with FIGS. 3 and 4 described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 2434, training data may include such user data. In implementations where users permit use of their respective user data, data 2432 may include permitted data.

In some implementations, data 2432 may include collected data such as cemetery application data. In some implementations, training data may include synthetic data generated for the purpose of training, such as data that is not based on user input or activity in the context that is being trained, e.g., data generated from simulated conversations, computer-generated images, etc. In some implementations, machine-learning application 2430 excludes data 2432. For example, in these implementations, the trained model 2434 may be generated, e.g., on a different device, and be provided as part of machine-learning application 2430. In various implementations, the trained model 2434 may be provided as a data file that includes a model structure or form, and associated weights. Inference engine 2436 may read the data file for trained model 2434 and implement a neural network with node connectivity, layers, and weights based on the model structure or form specified in trained model 2434.

Machine-learning application 2430 also includes a trained model 2434. In some implementations, the trained model 2434 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 2432 or application data 2414. Such data can include, for example, images, e.g., when the trained model is used for computerized cemetery monument application functions. Subsequent intermediate layers may receive as input output of nodes of a previous layer per the connectivity specified in the model form or structure. These layers may also be referred to as hidden layers. A final layer (e.g., output layer) produces an output of the machine-learning application. For example, the output may be a set of labels for an image, an indication that an image is functional, etc. depending on the specific trained model. In some implementations, model form or structure also specifies a number and/or type of nodes in each layer.

In different implementations, the trained model 2434 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 2434 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 2432, to produce a result.

For example, training may include applying supervised learning techniques. In supervised learning, the training data can include a plurality of inputs (e.g., a set of images) and a corresponding expected output for each input (e.g., one or more labels for each image representing aspects of a project corresponding to the images such as services or products needed or recommended). Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided, and the model may be trained to differentiate data, e.g., to cluster input data into a plurality of groups, where each group includes input data that are similar in some manner. For example, the model may be trained to identify computerized cemetery monument application task labels that are associated with images and/or select thresholds for computerized cemetery monument application recommendation or prediction.

In another example, a model trained using unsupervised learning may cluster words based on the use of the words in data sources. In some implementations, unsupervised learning may be used to produce knowledge representations, e.g., that may be used by machine-learning application 2430. In various implementations, a trained model includes a set of weights, or embeddings, corresponding to the model structure. In implementations where data 2432 is omitted, machine-learning application 2430 may include trained model 2434 that is based on prior training, e.g., by a developer of the machine-learning application 2430, by a third-party, etc. In some implementations, trained model 2434 may include a set of weights that are fixed, e.g., downloaded from a server that provides the weights.

Machine-learning application 2430 also includes an inference engine 2436. Inference engine 2436 is configured to apply the trained model 2434 to data, such as application data 2414, to provide an inference. In some implementations, inference engine 2436 may include software code to be executed by processor 2402. In some implementations, inference engine 2436 may specify circuit configuration (e.g., for a programmable processor, for a field programmable gate array (FPGA), etc.) enabling processor 2402 to apply the trained model. In some implementations, inference engine 2436 may include software instructions, hardware instructions, or a combination. In some implementations, inference engine 2436 may offer an application programming interface (API) that can be used by operating system 2408 and/or computerized cemetery monument application 2412 to invoke inference engine 2436, e.g., to apply trained model 2434 to application data 2414 to generate an inference.

Machine-learning application 2430 may provide several technical advantages. For example, when trained model 2434 is generated based on unsupervised learning, trained model 2434 can be applied by inference engine 2436 to produce knowledge representations (e.g., numeric representations) from input data, e.g., application data 2414. For example, a model trained for computerized cemetery monument application tasks may produce predictions and confidences for given input information about a computerized cemetery monument application. A model trained for suggesting computerized cemetery monument application tasks or approval likelihood and timelines may produce a suggestion for one or more phases of a computerized cemetery monument application, or a model for automatic estimating or evaluation of a computerized cemetery monument application may automatically estimate a project and/or evaluate completion of one or more phases of a computerized cemetery monument application project based on input images or other information. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 2436.

In some implementations, knowledge representations generated by machine-learning application 2430 may be provided to a different device that conducts further processing, e.g., over a network. In such implementations, providing the knowledge representations rather than the images may provide a technical benefit, e.g., enable faster data transmission with reduced cost.

In some implementations, machine-learning application 2430 may be implemented in an offline manner. In these implementations, trained model 2434 may be generated in a first stage and provided as part of machine-learning application 2430. In some implementations, machine-learning application 2430 may be implemented in an online manner. For example, in such implementations, an application that invokes machine-learning application 2430 (e.g., operating system 2408, one or more of computerized cemetery monument application 2412 or other applications) may utilize an inference produced by machine-learning application 2430, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 2434, e.g., to update embeddings for trained model 2434.

In some implementations, machine-learning application 2430 may be implemented in a manner that can adapt to particular configuration of device 2400 on which the machine-learning application 2430 is executed. For example, machine-learning application 2430 may determine a computational graph that utilizes available computational resources, e.g., processor 2402. For example, if machine-learning application 2430 is implemented as a distributed application on multiple devices, machine-learning application 2430 may determine computations to be carried out on individual devices in a manner that optimizes computation. In another example, machine-learning application 2430 may determine that processor 2402 includes a GPU with a particular number of GPU cores (e.g., 1000) and implement the inference engine accordingly (e.g., as 1000 individual processes or threads).

In some implementations, machine-learning application 2430 may implement an ensemble of trained models. For example, trained model 2434 may include a plurality of trained models that are each applicable to same input data. In these implementations, machine-learning application 2430 may choose a particular trained model, e.g., based on available computational resources, success rate with prior inferences, etc. In some implementations, machine-learning application 2430 may execute inference engine 2436 such that a plurality of trained models is applied. In these implementations, machine-learning application 2430 may combine outputs from applying individual models, e.g., using a voting-technique that scores individual outputs from applying each trained model, or by choosing one or more particular outputs. Further, in these implementations, machine-learning application may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 2408 or one or more other applications, e.g., computerized cemetery monument application 2412.

In different implementations, machine-learning application 2430 can produce different types of outputs. For example, machine-learning application 2430 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 2430 may produce an output video with a particular effect applied, e.g., rendered in a comic-book or particular artist's style, when trained model 2434 is trained using training data from the comic book or particular artist, etc. In some implementations, machine-learning application 2430 may produce an output based on a format specified by an invoking application, e.g., operating system 2408 or one or more applications, e.g., computerized cemetery monument application 2412. In some implementations, an invoking application may be another machine-learning application. For example, such configurations may be used in generative adversarial networks, where an invoking machine-learning application is trained using output from machine-learning application 2430 and vice-versa.

Any of software in memory 2404 can alternatively be stored on any other suitable storage location or computer-readable medium. In addition, memory 2404 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 2404 and any other type of storage (magnetic disk, optical disk, magnetic tape, or other tangible media) can be considered “storage” or “storage devices.”

I/O interface 2406 can provide functions to enable interfacing the server device 2400 with other systems and devices. Interfaced devices can be included as part of the device 400 or can be separate and communicate with the device 2400. For example, network communication devices, storage devices (e.g., memory and/or database 106), and input/output devices can communicate via I/O interface 2406. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 2406 can include one or more display devices 2420 and one or more data stores 2438 (as discussed above). The display devices 2420 that can be used to display content, e.g., a user interface of an output application as described herein. Display device 2420 can be connected to device 2400 via local connections (e.g., display bus) and/or via networked connections and can be any suitable display device. Display device 2420 can include any suitable display device such as an LCD, LED, or plasma display screen, CRT, television, monitor, touchscreen, 3-D display screen, or other visual display device. For example, display device 2420 can be a flat display screen provided on a mobile device, multiple display screens provided in a goggles or headset device, or a monitor screen for a computer device.

The I/O interface 2406 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 24 shows one block for each of processor 2402, memory 2404, I/O interface 2406, and software blocks 2408, 2412, and 2430. These blocks may represent one or more processors or processing circuitries, operating systems, memories, I/O interfaces, applications, and/or software modules. In other implementations, device 2400 may not have all of the components shown and/or may have other elements including other types of elements instead of, or in addition to, those shown herein. While some components are described as performing blocks and operations as described in some implementations herein, any suitable component or combination of components of environment 100, device 2400, similar systems, or any suitable processor or processors associated with such a system, may perform the blocks and operations described.

In some implementations, the computerized cemetery monument application system could include a machine-learning model (as described herein) for tuning the system (e.g., selecting computerized cemetery monument application labels and corresponding thresholds) to potentially provide improved accuracy. Inputs to the machine learning model can include ICA labels, an image descriptor vector that describes appearance and includes semantic information about computerized cemetery monument applications. Example machine-learning model input can include labels for a simple implementation and can be augmented with descriptor vector features for a more advanced implementation. Output of the machine-learning module can include a prediction of computerized cemetery monument application approval and/or completion timeline.

One or more methods described herein (e.g., methods of FIGS. 3 and 4) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
receiving a selection of a cemetery at a cemetery monument application user interface provided by a computerized cemetery monument application platform;
causing one or more elements of the cemetery monument application user interface to be enabled based on the cemetery selected;
receiving cemetery application information from a monument dealer system via the cemetery monument application user interface;
electronically transmitting notification of a completed cemetery monument application to an authorizing party system for approval;
obtaining electronic payment from the monument dealer system via a third-party payment acquisition platform;
placing at least a portion of the electronic payment into an electronic escrow account;
when electronic approval indication of the completed cemetery monument application is received from the authorizing party system, electronically transmitting the completed cemetery monument application to a cemetery system;
when electronic approval of the completed cemetery monument application is received from the cemetery, electronically releasing the at least a portion of the electronic payment held in electronic escrow, wherein a first portion of released escrow funds is provided to the cemetery and a second portion of funds released from escrow is provided to an operator of the computerized cemetery monument application platform;
when an indication that a monument foundation is ready, generating an electronic setting card including at least a portion of the cemetery monument application and an indication that the monument is approved for setting by the cemetery; and
transmitting the electronic setting card from the computerized cemetery monument application platform to one or more of the monument dealer system or the authorizing party system.

2. The method of claim 1, further comprising:
receiving, at the computerized cemetery monument application platform, an electronic monument order for a monument dealer registered with the computerized cemetery monument application platform;
providing a notification of the monument order to the monument dealer system;
generating, at the computerized cemetery monument application platform, an electronic image of a monument;
providing the electronic image of the monument from the computerized cemetery monument application platform to the authorizing party system;
when the electronic image of the monument is approved by the authorizing party system, providing a notification to the monument dealer and proceeding to the cemetery monument application process; and
when the electronic image of the monument is not approved by the authorizing party system, performing a design modification process.

3. The method of claim 1, further comprising:
storing, at the computerized cemetery monument application platform, an indication that the monument has been set.

4. The method of claim 1, further comprising:
transmitting, from the computerized cemetery monument application platform, to one or more of the monument dealer system or the authorizing party system, an electronic message indicating that the monument has been set.

5. The method of claim 1, further comprising:
determining, at the computerized cemetery monument application platform, that a photo is included in a design of the monument; and
requiring selection of a photo disclaimer within the cemetery monument application user interface.

6. The method of claim 1, further comprising:
determining, at the computerized cemetery monument application platform, that a burial spaces acknowledgement is required; and
requiring selection of a burial space acknowledgement statement within the cemetery monument application user interface.

7. The method of claim 1, further comprising:
determining, at the computerized cemetery monument application platform, that a new monument foundation is needed; and
programmatically determining a cost of the new monument foundation based on one or more settings associated with the cemetery within the computerized cemetery monument application platform.

8. The method of claim 1, further comprising:
determining, at the computerized cemetery monument application platform, that a vase in included in a design of the monument; and
requiring selection of a vase disclaimer within the cemetery monument application user interface.

9. A computerized cemetery monument application platform comprising:
one or more processors coupled to a computer-readable medium having stored thereon software instructions that, when executed by the one or more processors, cause the one or more processors to perform operations including:
receiving a selection of a cemetery at a cemetery monument application user interface provided by the computerized cemetery monument application platform;
causing one or more elements of the cemetery monument application user interface to be enabled based on the cemetery selected;
receiving cemetery application information from a monument dealer system via the cemetery application user interface;
electronically transmitting notification of a completed cemetery monument application to an authorizing party system for approval;
obtaining electronic payment from the monument dealer system via a third-party payment acquisition platform;
placing at least a portion of the electronic payment into an electronic escrow account;
when electronic approval indication of the completed cemetery monument application is received from the authorizing party system, electronically transmitting the completed cemetery monument application to a cemetery system;
when electronic approval of the completed cemetery monument application is received from the cemetery, electronically releasing the at least a portion of the electronic payment held in electronic escrow, wherein a first portion of released escrow funds is provided to the cemetery and a second portion of funds released from escrow is provided to an operator of the computerized cemetery monument application platform;
when an indication that a monument foundation is ready, generating an electronic setting card including at least a portion of the cemetery monument application and an indication that the monument is approved for setting by the cemetery; and
transmitting the electronic setting card from the computerized cemetery monument application platform to one or more of the monument dealer system or the authorizing party system.

10. The computerized cemetery monument application platform of claim 9, wherein the operations further comprise:
receiving, at the computerized cemetery monument application platform, an electronic monument order for a monument dealer registered with the computerized cemetery monument application platform;
providing a notification of the monument order to the monument dealer system;
generating, at the computerized cemetery monument application platform, an electronic image of a monument;
providing the electronic image of the monument from the computerized cemetery monument application platform to the authorizing party system;
when the electronic image of the monument is approved by the authorizing party system, providing a notification to the monument dealer and proceeding to the cemetery monument application process; and
when the electronic image of the monument is not approved by the authorizing party system, performing a design modification process.

11. The computerized cemetery monument application platform of claim 9, wherein the operations further comprise:
storing, at the computerized cemetery monument application platform, an indication that the monument has been set.

12. The computerized cemetery monument application platform of claim 9, wherein the operations further comprise:
transmitting, from the computerized cemetery monument application platform, to one or more of the monument dealer system or the authorizing party system, an electronic message indicating that the monument has been set.

13. The computerized cemetery monument application platform of claim 9, wherein the operations further comprise:
determining, at the computerized cemetery monument application platform, that a photo is included in a design of the monument; and
requiring selection of a photo disclaimer within the cemetery monument application user interface.

14. The computerized cemetery monument application platform of claim 9, wherein the operations further comprise:
determining, at the computerized cemetery monument application platform, that a burial spaces acknowledgement is required; and
requiring selection of a burial space acknowledgement statement within the cemetery monument application user interface.

15. The computerized cemetery monument application platform of claim 9, wherein the operations further comprise:
determining, at the computerized cemetery monument application platform, that a new monument foundation is needed; and
programmatically determining a cost of the new monument foundation based on one or more settings associated with the cemetery within the computerized cemetery monument application platform.

16. The computerized cemetery monument application platform of claim 9, wherein the operations further comprise:
determining, at the computerized cemetery monument application platform, that a vase in included in a design of the monument; and
requiring selection of a vase disclaimer within the cemetery monument application user interface.

17. A computer-readable medium having stored thereon software instructions that, when executed by one or more processors, cause the one or more processors to perform operations including:
receiving a selection of a cemetery at a cemetery monument application user interface provided by a computerized cemetery monument application platform;
causing one or more elements of the cemetery monument application user interface to be enabled based on the cemetery selected;
receiving cemetery application information from a monument dealer system via the cemetery application user interface;
electronically transmitting notification of a completed cemetery monument application to an authorizing party system for approval;
obtaining electronic payment from the monument dealer system via a third-party payment acquisition platform;
placing at least a portion of the electronic payment into an electronic escrow account;
when electronic approval indication of the completed cemetery monument application is received from the authorizing party system, electronically transmitting the completed cemetery monument application to a cemetery system;
when electronic approval of the completed cemetery monument application is received from the cemetery, electronically releasing the at least a portion of the electronic payment held in electronic escrow, wherein a first portion of released escrow funds is provided to the cemetery and a second portion of funds released from escrow is provided to an operator of the computerized cemetery monument application platform;
when an indication that a monument foundation is ready, generating an electronic setting card including at least a portion of the cemetery monument application and an indication that the monument is approved for setting by the cemetery; and
transmitting the electronic setting card from the computerized cemetery monument application platform to one or more of the monument dealer system or the authorizing party system.

18. The computer-readable medium of claim 17, wherein the operations further comprise:
receiving, at the computerized cemetery monument application platform, an electronic monument order for a monument dealer registered with the computerized cemetery monument application platform;
providing a notification of the monument order to the monument dealer system;
generating, at the computerized cemetery monument application platform, an electronic image of a monument;
providing the electronic image of the monument from the computerized cemetery monument application platform to the authorizing party system;
when the electronic image of the monument is approved by the authorizing party system, providing a notification to the monument dealer and proceeding to the cemetery monument application process; and
when the electronic image of the monument is not approved by the authorizing party system, performing a design modification process.

19. The computer-readable medium of claim 17, wherein the operations further comprise:
storing, at the computerized cemetery monument application platform, an indication that the monument has been set.

20. The computer-readable medium of claim 17, wherein the operations further comprise:
transmitting, from the computerized cemetery monument application platform, to one or more of the monument dealer system or the authorizing party system, an electronic message indicating that the monument has been set.
